(19) United States
(12) Patent Application Publication
(10) Pub. No.: US 2008/0213741 A1
(43) Pub. Date: Sep. 4, 2008

(54) DISTRIBUTED LEARNING PLATFORM SYSTEM

(76) Inventors: Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,338

(22) Filed: Sep. 6, 2007

Related U.S. Application Data
(60) Provisional application No. 60/824,750, filed on Sep. 6, 2006.

(51) Int. Cl. G09B 19/00

(52) U.S. Cl. 434/365

(57) ABSTRACT

A system for distributing educational information includes compiling educational information from educational sources. The user connects to a management system through a network connection. A user account may be authenticated with a user identification. The management system then transmits a plurality of educational material that may be used and operated on the user's computer when the user is offline. Later, the management system performs a sync operation when the user is able to reconnect to the system.

### CROSS-REFERENCE TO RELATED APPLICATIONS

This application claims priority to U.S. Provisional Application Ser. No. 60/824,750, filed on Sep. 6, 2006, and is incorporated herein by reference in its entirety.

### BACKGROUND OF THE INVENTION

1. The Field of the Invention

The invention generally relates to online systems for educational course materials, and more particularly to systems for distributing online courses with periodic synchronization and distribution of course information.

2. The Relevant Technology

Web-based learning management systems (LMS) and content management systems (CMS) have been increasingly used by corporations, government agencies, and higher education institutions as effective and efficient learning tools. A LMS is a software package that facilitates the management and delivery of online content to learners, often in order to enable the individualized and flexible access to learning content. Typically, an LMS allows for an online teaching environment, which a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, students and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give students key information they need outside the confines of the traditional university buildings or classrooms. The distance learning students can gain access to the course materials by connecting to the Internet or other global network. Thus, several institutions have implemented online or hybrid courses where the course is administered wholly or partially in the online setting.

Despite these advantages, however, these systems present problems when educators or students are traveling and cannot connect to the corporate LMS or online courses. Likewise, deployed troops have limited connectivity to courses in the field. Many students are on a tight budget and have slow or no connectivity when off campus. And faculty who want to continue to do their work when they are at an offsite event are unable to work when away from their network. Thus, the present systems are limited because they require constant access to the Internet or similar network connection.

### BRIEF SUMMARY OF THE INVENTION

The invention generally relates to online systems for educational course materials, and more particularly, to systems for distributing online courses with periodic synchronization and distribution of course information.

One aspect of the present invention is a method of distributing educational information in a computing environment, including an educational management system comprising a server and educational information. The method includes allowing a user to connect a computing device to the educational management system server through a network connection, transferring a plurality of educational information from the educational management system to the computing device, and performing a sync operation when the computing device is connected to the educational management system, wherein the plurality of educational information includes data and computer programs that are capable of performing computing functions in the computing device while not connected to the network.

Another aspect of the present invention is a system for distributing educational information, comprising a plurality of user computing devices capable of connecting to an education management system through a network connection, an education management system comprising a server capable of sending and receiving a plurality of educational information with the user computing devices, wherein the plurality of educational information includes data and computer programs that are capable of performing computing functions on the user computing devices when the user computing devices are not connected to the education management system through the network.

Advantageously, the present invention allows users of the system to access and utilize the educational content while offline, greatly expanding the usefulness and efficiency of online current educational systems. Aspects of the system may be used by students, educators, and course administrators alike. Thus students can continue learning regardless of their present network interconnectivity, and teachers and course administrators can continue to create and develop new content beyond the confines of the classroom.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating the method of the present invention;

FIGS. 3-4 are block diagrams illustrating the method of the invention in a networked computing system;

FIG. 5 is a diagram illustrating the various services available via the distributed access protocol according to one aspect of the invention;

FIG. 6 is a diagram illustrating examples of the various integrating learning solutions that may be used in association with the invention;

FIG. 7 is an exemplary user interface illustrating the multimedia support that may be available while the user is offline;

FIG. 8 is an exemplary user interface illustrating a digital note taking application that may be available while the user is offline;

FIG. 9 is an exemplary user interface illustrating a searching application that may be available while the user is offline; and

FIG. 10 is an exemplary user interface illustrating a personal planner application that may be available while the user is offline.

### DETAILED DESCRIPTION OF THE VARIOUS EMBODIMENTS

The principles of the various embodiments are described using the structure and operation of examples to illustrate the present invention. The various embodiments provide the capability to utilize the online courses with no or intermittent Internet access and enables the periodic synchronization of information, such as course materials, tests, bulletin boards, grade books, quizzes, discussion threads, message boards, and the like.

As used herein, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

In each case, the distributed nature of the present invention allows the various users to utilize aspects of the educational system while offline, meaning that the users may continue working regardless of their present interconnectivity. As discussed more specifically below, the system operates by distributing various learning software onto the user computer when the user is connected to the system, wherein the learning software continues being used when the user is no longer connected to the system. Later, when the user connects to the system, the user's computer and the educational system perform a syncing operation. During the syncing operation, the educational system receives any work or new data that has been created or modified while the user's computer was offline and the user's computer receives any new information or data available on the educational system.

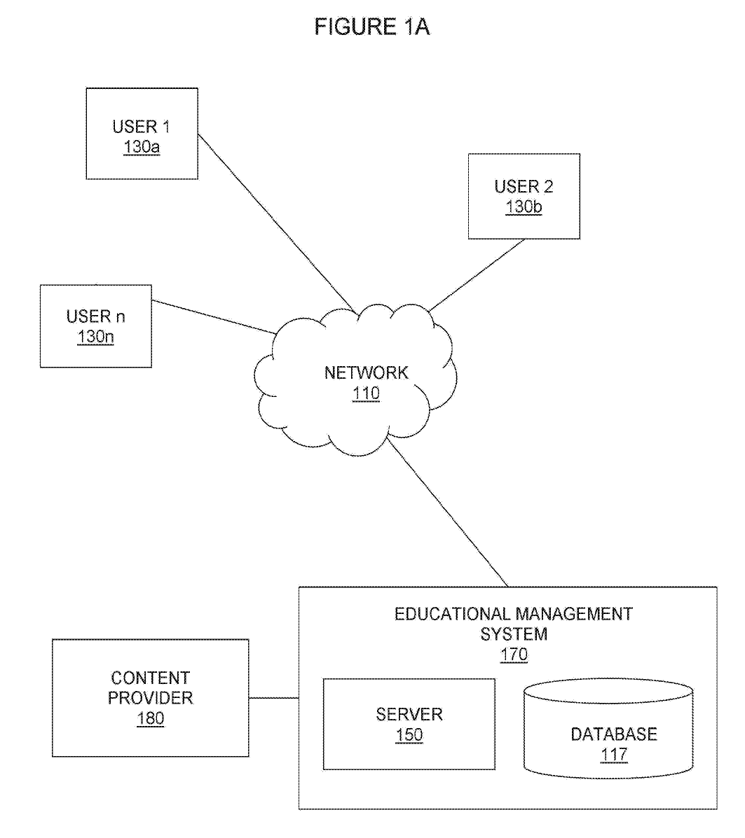

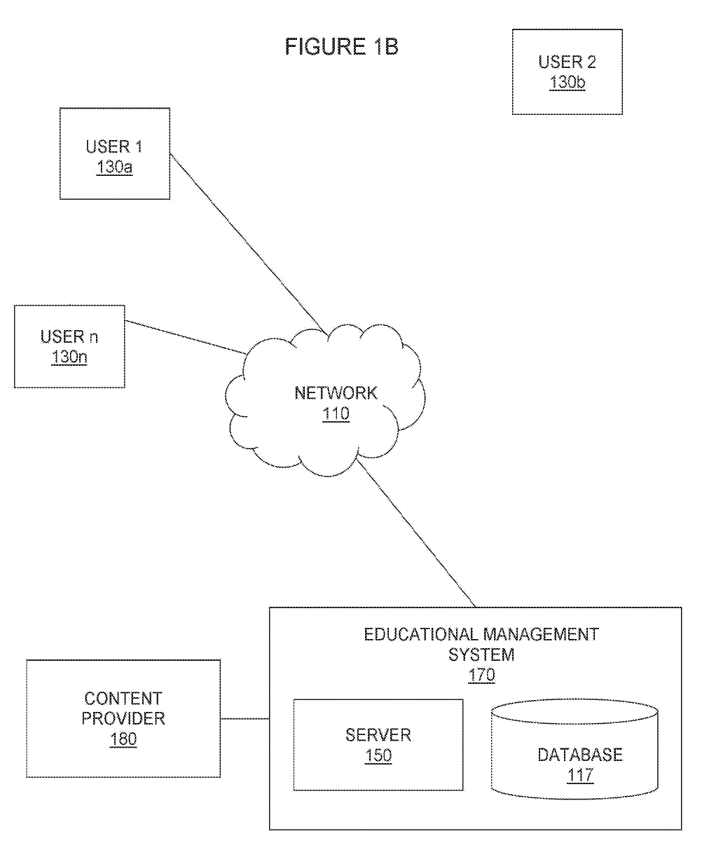

FIG. 1A is a block diagram illustrating an exemplary system capable of performing the present invention. As shown, the system includes a number of users, “User 1” 130a through “User n” 130n, who are connected to an educational management system 170 via a network connection 120. As will be understood by one of ordinary skill in the art, the network 120 may be any local or global network, including a LAN, WAN, wireless network, internet connection, and the like.

In one embodiment of the invention, the education management system 170 includes a server 150 capable of sending and receiving communications and data via the network 120, along with a database 160 capable of storing a plurality of educational software and data. In addition, the database 160 can be used to store data relating to the user identification. As will be understood by one of ordinary skill in the art, any number of configurations may be used to create an education system, including systems using a series of interconnected databases, computers, and servers.

In this example, the education management system 170 is connected to a content provider 180. Here, the content provider 180 may be a third party content provider, who is responsible for creating various course software. In contrast, the content provider 180 may be part of the education management system 170. Further, the content provider 180 may be an educator or course developer who connects to the education management system 170 as a user.

According to one embodiment of the present invention, the system may use a mechanism such as a bit torrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. A scheduled download can populate the user's computers with course content over a controlled distribution.

Thus, in situations where a large number of identical files need to be distributed to a number of users of the system, say at the beginning of a semester or session, when each student of the program requires the content associated with the course, the present invention may be effectively distributed without overwhelming the education management system 170.

In certain embodiments, the server is physically located a long distance away from the learning institution. For example, the server might be managed by an Application Service Provider under contract to the learning institution. In that case, communications between the users' computers and the server must pass over the internet. This can be inefficient and can overwhelm the institution's internet connection when most of the users are downloading the same items. This problem is mediated by the placement of a caching server at the institution. When an item is requested by the first computer, the caching server requests it from the main server over the internet. For the second and subsequent user's computers the caching server can serve it directly over the local-area network at the institution thereby greatly reducing demand on the internet connection.

In a similar way, there are systems such as independent study systems where the students and teachers operate primarily from home. In those situations, a distributed caching or content distribution service such as Akamai or Limelight may be used.

FIG. 1B illustrates the ability of the present invention to be used when a user, here “User 2” 130b is no longer connected to the education management system 170. As described more fully below, one advantage of the present invention is the ability to transfer or distribute software and/or data onto “User 2's” 130b computer which enable “User 2” 130b to continue using the educational software when the computer is not connected to the management system 170. According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

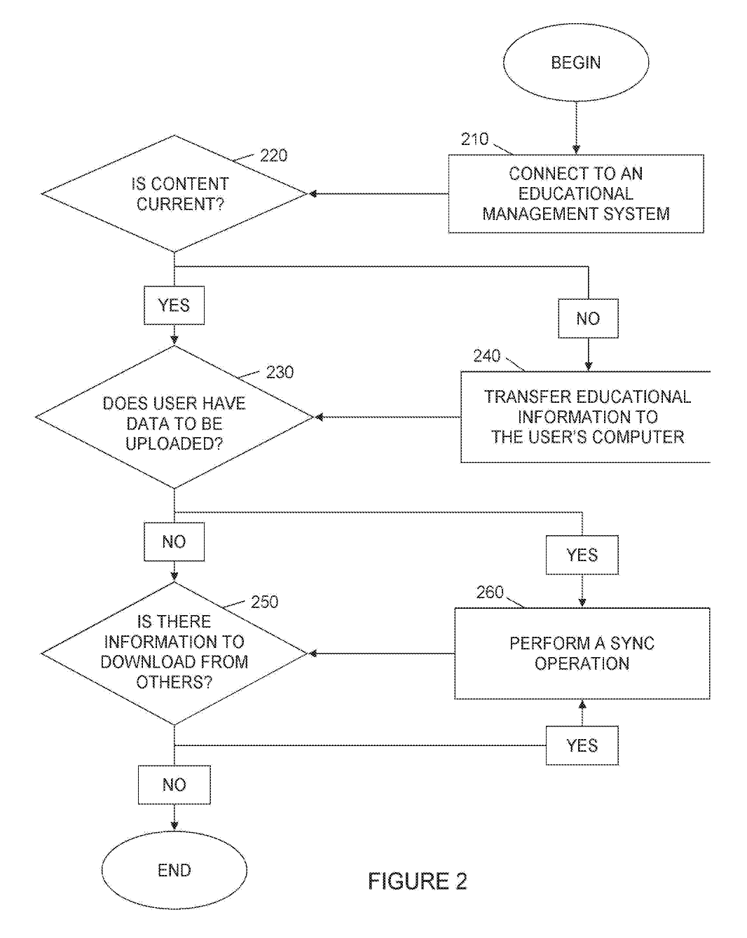

FIG. 2 is a block diagram illustrating a method for performing the present invention in a networked computer environment. At step 210, a user operating a computing device is allowed to connect to the education management system through a network connection. Optionally, this may involve an authentication process wherein user identification information is sent to the system in order to gain access to the system. At step 220, the system determines whether the educational content and information on the user's computing device is current. If the user's content is not current, then at step 240, the system transfers a plurality of educational information to the user, and continues to step 230. According to the invention, the educational information includes data and software that is capable of performing various functions regardless of connectivity to the system. Examples of data and software that may be transferred is described more fully below.

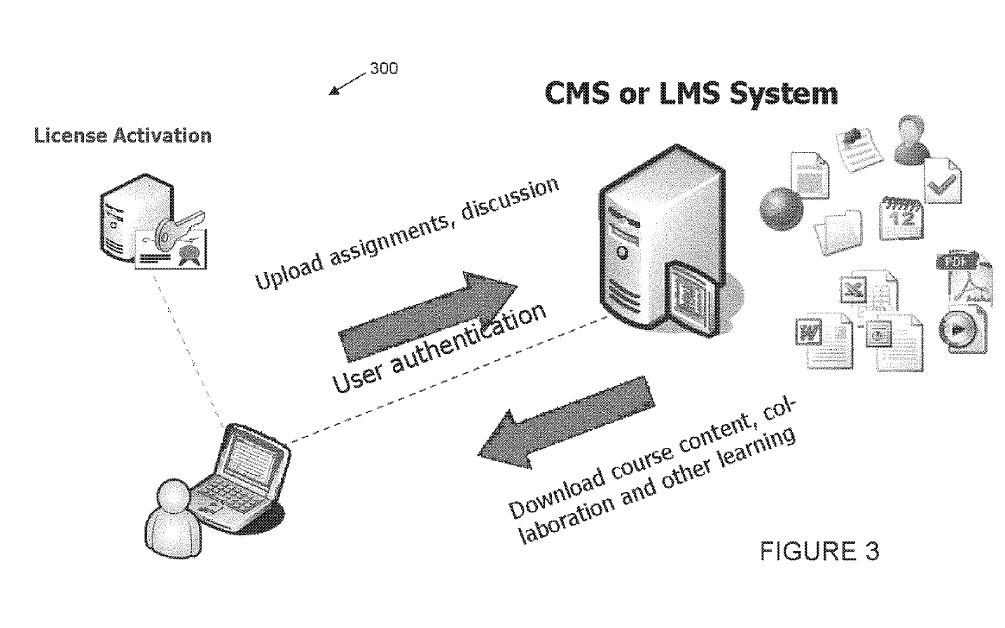

Returning now to FIG. 3, if at 220 the system determines that the user's computing device has current content, then at step 230 the system determines whether the user has data or educational information on the computing device that needs to be uploaded to the education management server. If at step 230 the system determines that the user's computer has data that needs to be uploaded, then at step 260 the system performs a sync operation and continues to step 250. If at step 240 the system determines that the user's computer does not need to upload content onto the education management system, the system continues to step 250, where the system determines if the user's computer requires any educational content that needs to be downloaded from other users of the system. If so, then at step 260, the system performs a sync operation with the other user's computer, and returns to step 250 to determine if the user's computer requires any additional content from other users. This continues until the system determines that there is no more educational content that needs to be downloaded from others, wherein the transfer process ends.

As shown in FIG. 3, in order to perform the offline aspects of the present invention, the system 300 includes a platform to distribute various types of learning software to the user's computer. The educational content of the system can include Blackboard Backpack, Higher Ed Holdings Epic, Thompson Reader, or other software that can be coupled to the educational distribution system. FIG. 3 illustrates examples of educational programs that can be downloaded and distributed to a user's computer. By using this software individually or in combination, the system enables users to enroll in online courses to download course material, announcements, and bulletin board discussions. After this material has been downloaded or transferred to the user's computer, the user is able to access the programs and educational content while offline.

One aspect of the invention is that while the user is working offline, the system retains the learning functions. The user, for instance, is able to study course content and respond to bulletin board messages when working offline. Similarly, educators and course administrators are able to create or combine new course material, respond to bulletin board messages, and grade assignments or tests while offline. Later, when a connection is available and the user logs into the network, the user can upload the work he or she has completed while offline and check for new course material. The system can accommodate multiple users from various learning environments that are leveraged by schools. The system can also track course delivery.

Advantageously, distributed learning enables the important components of an e-learning infrastructure to be distributed where and when needed, so that students, faculty, and workers that are not connected to the network can continue their learning and education anytime, anywhere. The users can review for an exam, continue a SCORM-based course, respond to a discussion thread, view a recording of a missed class, create new content, or grade digitally turned-in assignments without the need for network access. Distributed learning extends the usefulness and scope of the present e-learning systems.

Distributed learning applications provide education institutions, corporations and government agencies with a number of benefits. Returning to FIG. 3, the user logs into the management system, such as CMS or LMS, to upload assignments, course status, or participate in discussion threads. And the user can download course content, collaboration with other users, or other learning objects. The user is not required to be connected to the management system to be able to work on the course materials. For example, the system enhances efficiencies of existing LMS or CMS system to users by expanding usage and minimizing downtime and leverages existing LMS or CMS infrastructure minimizing or eliminating need for changes. Also, it minimizes the need to have a 24/7 infrastructure to support LMS or CMS systems as users carry a copy with them. The system enables mobile workers, troops, faculty and students to be more efficient and effective by leveraging time that is often unproductive. And it allows users to personalize learning content through annotation, organization and digital additions, making their learning more effective.

Another aspect of the present invention includes a platform designed to enable rapid development of partner-branded distributed learning applications. In addition, the system takes learning to a new level by giving students, professionals, and teachers additional tools to discover, capture, organize, annotate, and search learning content, making it easier to personalize the system to meet the user's individual needs.

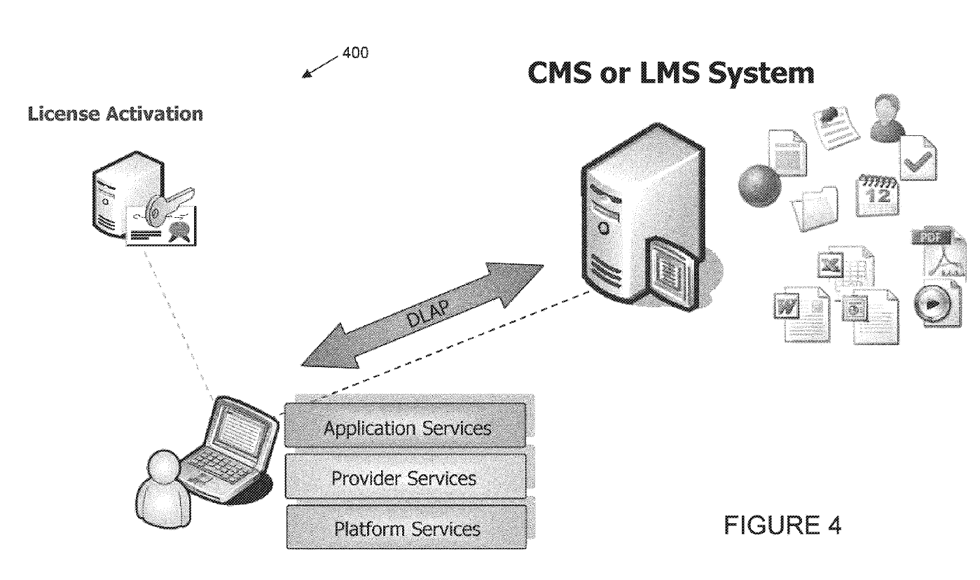

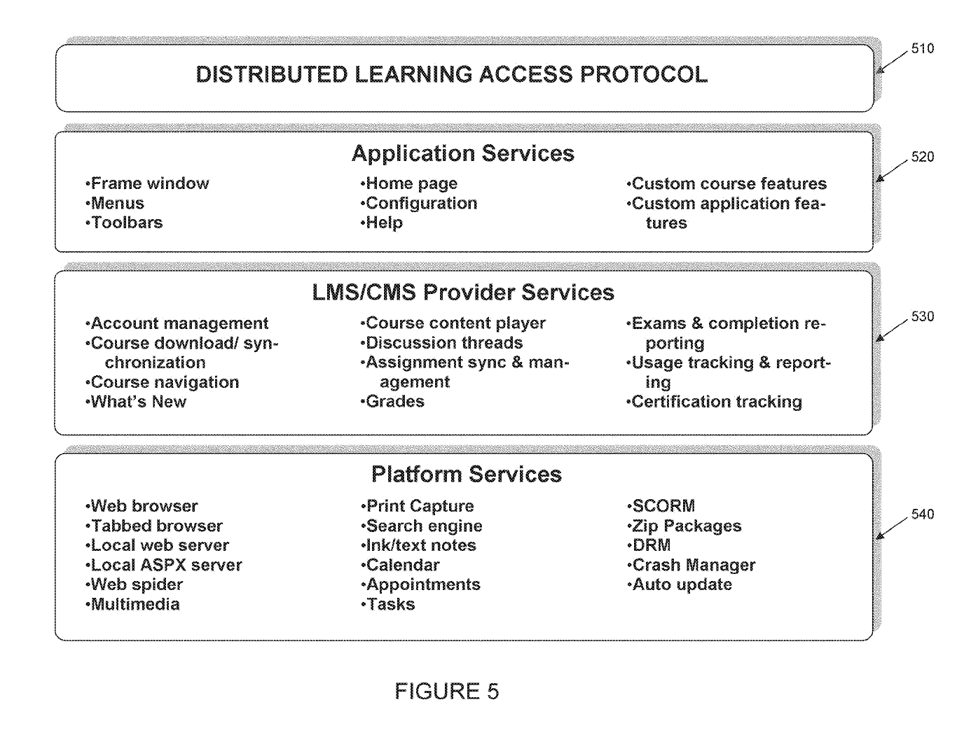

One powerful aspect of this distributed learning platform is the existing suite of components that enable rapid development. The architecture can be divided into four major layers: platform services, provider services, application services, and the distributed learning access protocol (DLAP) as illustrated in FIG. 4.

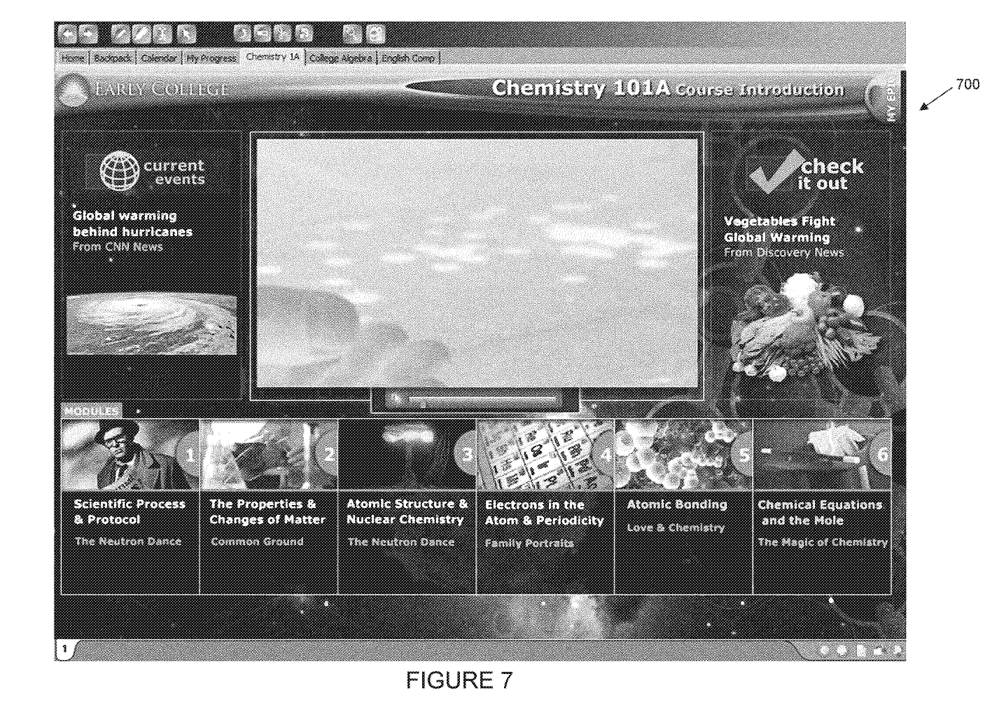

The platform services 540, as shown in FIG. 4, are the core components upon which partner-branded applications are built. Some known components are Microsoft.NET ink and text note-taking control. In addition, these services include a web browser built on Internet Explorer controls that enable the application to play any content that works with Internet Explorer, including support for multimedia like Flash, QuickTime, Windows Media, and the like. A built-in offline SCORM content player is supported within the system, such as the exemplary player 700 illustrated in FIG. 7. A print capture engine takes any Windows application print output and converts it to a digital note. Platform services support a robust search engine, built-in DRM, calendar, and local web, and ASPX servers. To support application management, the platform services also include an optional license activation manager to prevent unauthorized copying, a crash manager to help isolate problem areas and an auto-update service to keep user applications at the latest release level.

As previously discussed, one aspect of the system is to download and upload objects from and/or to the CMS and LMS systems. To support that function, the second level of the distributed learning platform is the provider services 530 or the built-in support for common CMS and LMS objects. The support serves can include course content, account management, course navigation, content playing, discussion threads, exams, certification tracking, SCORM learning objects, collaboration, assignments, grades, assessments, professor/course rating, and usage activity tracking. Objects can be downloaded or uploaded during any sync session. The application can be set up to support automatic or manual synchronization, with automatic synchronization done on a time-basis or by a specific event. The system also supports connection and user management to maintain links and user account authentication information. The user is authenticated when an identification number or other user identification, such as a user name and password or secure ID, is submitted to the provider and verified against a given account under the provider's license. Support for additional LMS and CMS objects also can be added to the system including a personal learning and research repository, PDF, MS Office, document annotation, digital note-taking, assignment planners, and search programs.

The third layer of the distributed learning platform are the application services 520, which help the application branding effort in order to create the right look and feel for the educational content. Application services 520 include the user interface components, such as windows, menus, toolbars, home pages, help, course support, and other custom features. The application services have support for 508 accessibility support. Also included is a configuration tool that makes it easy to create the user-defined options for the application. Custom components can be quickly built to meet unique needs of the partner-branded application.

In order for distributed learning applications to work, a set of APIs are available from the LMS or CMS system as a web service that can deliver high performance to the application built on the system. A web services-based protocol called Distributed Learning Access Protocol (DLAP) 510 can be used between any distributed learning client and any LMS or CMS server. It is designed for very high performance, supports DRM-secure communications, and supports both learner and teacher activities. The system can include the DLAP and the related methods of permitting future third-party online eLearning systems to use defined application program interfaces that will facilitate interoperability and standardization.

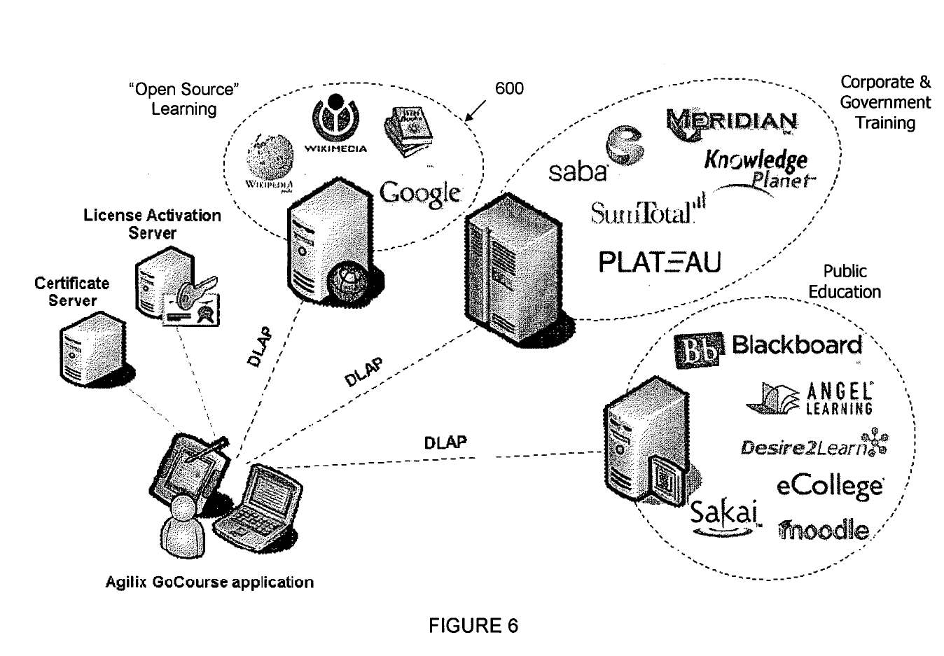

Using the previously mentioned tools, a partner-branded application can include all of the key functionality requirements in order to fit the target user. Some of the application modules are outlined below that can comprise the client. Other examples 600 are illustrated in FIG. 6.

The system has the ability to send and receive content to and from the e-learning system. Supported content includes SCORM courses, course documents, discussion threads, and other asynchronous collaboration, assignments, grade book, usage status, and assessments. The system supports “round tripping” enabling content to be download or uploaded as necessary. Automatic or manual synchronization, whenever a network connection is available, is supported to keep content current and up-to-date. The course information can be bidirectional and sequential synchronized. This synchronization or “roundtripping” feature updates assignments and assessments. Students can download assignments and assessments to work on them in a environment that is disconnected from the network. The user can also upload results when a connection to the CMS/LMS is established. Furthermore, a user can also download instructor's comments and grades, and resubmit assignments.

In another aspect of the present invention, the course development system may support a course, content, or professor rating program. This rating may be collected from students or colleagues of an educator or program at any time during the duration or conclusion of any course, and may be used to assist faculty in developing new course materials. Further, an educator may download the comments and suggestions from students and teachers.

According to another embodiment, the system may alert a course administrator that an educator with a high approval rating has recently submitted new course content for review, or conversely, the system may notify an educator when one of his or her courses is systematically receiving poor reviews, perhaps suggesting that the course needs changing. As with any rating system, it will be appreciated that there are various ways for a user to rank their approval or disapproval, including, but not limited to, 1-5 star-rankings, percentages, thumbs-up/thumbs-down indicators, number-scale rankings, or the like. Furthermore, the ranking or feedback may be automatically generated based on an objective evaluation of student performance.

The system can support a variety of offline teacher support programs, including a grade book or spreadsheet-like application which allows an educator to manage all students and their grades for each gradable object. Using similar techniques, the system enables a teacher to download any completed work, including assignments, quizzes, or tests that have previously been completed and submitted to the system by users who are students.

The system can also support course development programs, such as an authoring client software product which enables an author to create educational content. Such programs can enable learning unit authoring, exam editing, HTML editing, rich media support, document attachment, support for ZIP files, and grade book and assignment creators. The program may also provide the author the ability to review the course and the ability to later publish it to the educational management service, during a sync or similar operation.

According to one embodiment of the invention, the system can also support a collaborative course authoring environment, where several educators and content providers can work together to develop course content. In one embodiment, the course content may be developed using a educator wiki-style program or similar environment where authorized users may download educational content and later create additional content, edit, remove, or change content, which may be uploaded to the educational server later in order to create course content in a collaborative manner. Advantageously, such a system would enable busy educators to easily and efficiently work together to create educational content.

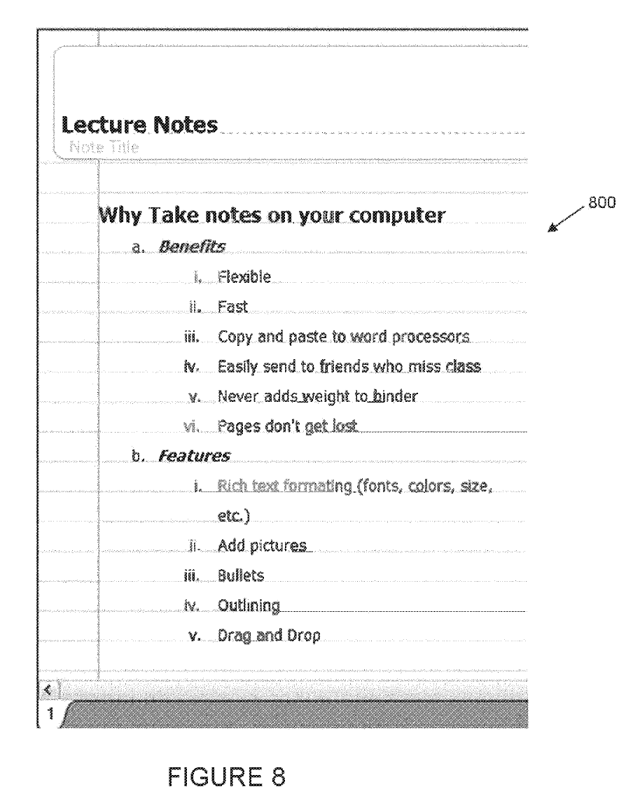

In addition to offering offline support, the present invention includes offline support for students. Examples of applications that may be useful to students include a digital note taking application, such as the sample 800 illustrated in FIG. 8. One example of one such application is Agilix InfiNotes, which supports object-based note-taking with unlimited digital filler paper, rich text editing, and keyboard and ink support. It also allows users to add flags, hyperlinks to web pages and local documents and images to any notes. And all notes are fully searchable, including digital ink written words.

The system can also capture a certified print driver that transforms printed output from any Windows XP application to an annotatable, InfiNotes-compatible note. Users can add their own notes, highlights and drawings to the digital note. And all text printed to the note is fully searchable.

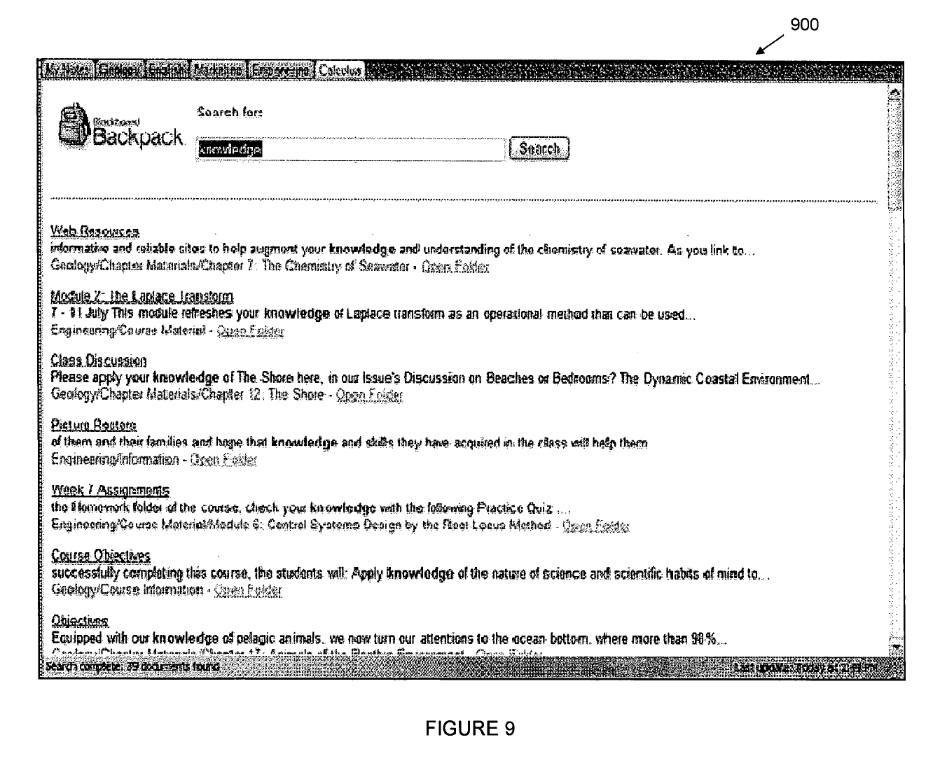

All downloaded content, handwritten notes and captured documents can be searched with a search engine, and may be accessed with a personal research function. In one embodiment, this function can support full annotation such as highlighting, digital notes, hyperlinks, and pictures, such as those shown in FIG. 7. The search engine displays results in order based on relevancy, operating just like a browser, without requiring the same network connectivity. Once displayed, the users can filter the results by course, personal notes, type of captured documents, as shown in FIG. 9.

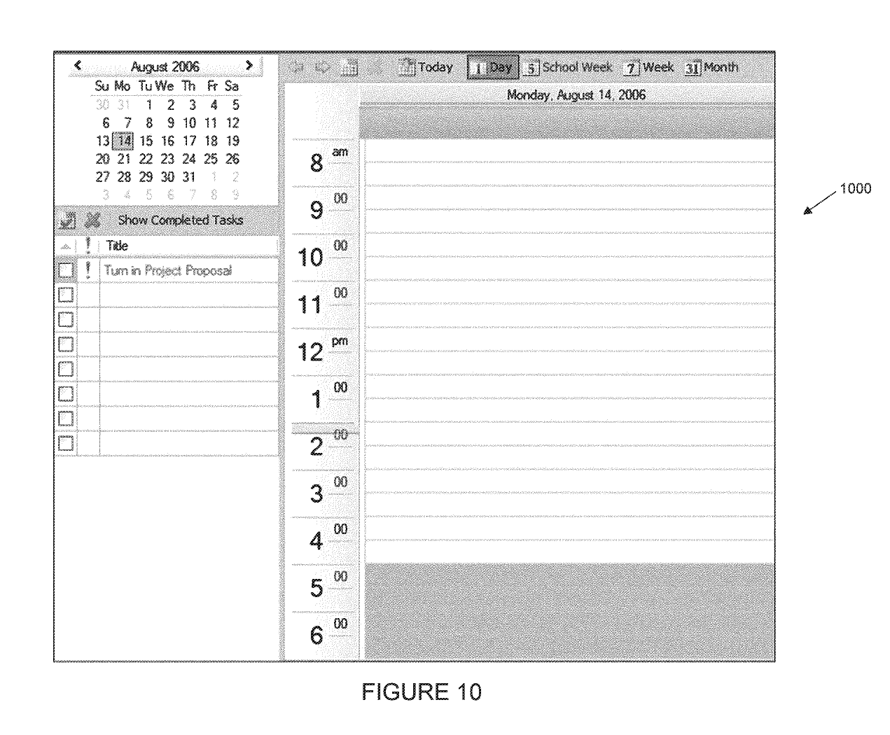

Based on the needs of the target audience, the application can also include a calendar with four displays: daily, 5-day week, 7-day week and month, as depicted in FIG. 10. Advantageously, the calendar toolbar makes it easy to switch between views and add new appointments. In addition, the calendar can include a task manager to keep track of action items and assignments. Both the calendar and the task manager can be viewed based on a specific course or global information.

The applications may be developed with specific product specifications for a given application. The system can include server APIs to download and upload the learning objects. For example, the system can include DLAP, however, most SOAP/WSDL-based protocols will work, although some enhancements may be required to meet functionality and performance requirements. The system can also include access to test servers with sample content. In this way, the system can be developed and tested to make the solution meet specific user specifications.

One advantage of the distributed learning platform is that it has wide applicability. The system supports all Windows XP computers running SP2. For example, it can be built on the .NET Framework 2.0. The system can also support Windows Vista or other operating platforms.

Thus, the distributed learning platform provides the architectural and software support and development that is required in order to create a stable learning environment that continues to be useful when the user is offline. The system includes aspects that are useful to students and educators alike. It allows students to continue learning at their own pace, in their chosen environment, and according to the demands of their own personal schedule. Further, it gives educators and faculty the freedom and the tools to develop and administer educational content that is more effective.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, including an educational management system comprising a server and educational information, a method for distributing the educational information, the method comprising:
allowing a user to connect a computing device to the educational management system server through a network connection;
transferring a plurality of educational information from the educational management system to the computing device; and
performing a sync operation when the computing device is connected to the educational management system;
wherein the plurality of educational information includes data and computer programs that are capable of performing computing functions in the computing device while not connected to the network.

2. The method of claim 1, further comprising compiling educational information from a plurality of educational sources and distributing it using a uniform computer communications protocol.

3. The method of claim 1, wherein the educational information and computer programs comprises course content that is created using a collaborative or wiki style content authoring software.

4. The method of claim 1, wherein allowing a user to connect a computing device to the educational management system comprises authenticating a user account using a user identification.

5. The method of claim 1, wherein the user at least one of the following: a student, an educator, a course administrator, educational information provider, employer, or employee.

6. The method of claim 1, wherein the educational information and computer programs comprise course content, assignments, grade books, rating/feedback mechanisms, discussion threads, message board updates, assessments, a multimedia browser, a digital note taker, a print driver transform, course or professor rating system, or content authoring software.

7. The method of claim 1, wherein the educational information and computer programs are distributed to the computing device using a peer-to-peer communications protocol for file sharing among the various computing devices which are connected to the system.

8. The method of claim 1, wherein the educational management system comprises a primary server and a caching server, wherein the primary server is capable of storing educational content and the caching server is capable of storing copies of the educational content on the primary server, and wherein transferring a plurality of educational information from the educational management system comprises transferring information from the caching server to the user's computing device.

9. In a computing environment, including an educational management system comprising a server and educational information, a method for distributing the educational information, the method comprising:
allowing a user to connect a computing device to the educational management system server through a network connection; and
transferring a plurality of educational information from the educational management system to the computing device using a single communications protocol when the computing device is connected to the educational management system;
wherein the plurality of educational information includes data and computer programs that are capable of performing computing functions in the computing device while not connected to the network while have been compiled from a plurality of educational sources.

10. The method of claim 9, wherein the educational information and computer programs comprises course content that is created using a collaborative or wiki style content authoring software.

11. The method of claim 9, wherein allowing a user to connect a computing device to the educational management system comprises authenticating a user account using a user identification.

12. The method of claim 9, wherein the user at least one of the following: a student, an educator, a course administrator, educational information provider, employer, or employee.

13. The method of claim 9, wherein the educational information and computer programs comprise course content, assignments, grade books, rating/feedback mechanisms, discussion threads, message board updates, assessments, a multimedia browser, a digital note taker, a print driver transform, course or professor rating system, or content authoring software.

14. The method of claim 9, wherein the educational information and computer programs are distributed to the computing device using a peer-to-peer communications protocol for file sharing among the various computing devices which are connected to the system.

15. The method of claim 9, wherein the educational management system comprises a primary server and a caching server, wherein the primary server is capable of storing educational content and the caching server is capable of storing copies of the educational content on the primary server, and wherein transferring a plurality of educational information from the educational management system comprises transferring information from the caching server to the user's computing device.

16. A system for distributing educational information, the system comprising:
a plurality of user computing devices capable of connecting to an education management system via a network connection; and
an education management system comprising a server capable of sending and receiving a plurality of educational information with the user computing devices;
wherein the plurality of educational information includes data and computer programs that are capable of performing computing functions on the user computing devices when the user computing devices are not connected to the education management system via the network.

17. The system according to claim 14, wherein the education management system is capable of compiling educational information from a plurality of educational sources.

18. The system according to claim 15, wherein the educational management system distributes the compiled educational information from a plurality of educational sources to the user computing devices using a single communications protocol.

19. The system according to claim 14, wherein the education management system is capable of authenticating a user account using a user identification.

20. The system according to claim 14, wherein the plurality of user computing devices are capable of connecting to other user computing devices in order to send and receive educational information.

21. The system of claim 14, wherein the educational information and computer programs comprise course content, assignments, grade books, discussion threads, message board updates, assessments, a multimedia browser, a digital note taker, a print driver transform, course or professor rating system, or content authoring software.

22. The system of claim 14, wherein the server of the educational server is a primary server capable of storing educational content, and the educational management system further comprises a caching server capable of storing a copy of the educational content stored on the primary server and transferring a plurality of educational information from the educational management system to the user's computing device.
